(19) United States
(12) Patent Application Publication
(10) Pub. No.: US 2026/0134831 A1
(43) Pub. Date: May 14, 2026

(54) Display Device and Display Driving Method

(71) Applicant: LG Display Co., Ltd., Seoul (KR)

(72) Inventors: JaeKyeong Yun, Paju-si (KR); Dongkyun Woo, Paju-si (KR)

(21) Appl. No.: 19/310,589

(22) Filed: Aug. 26, 2025

(30) Foreign Application Priority Data
Nov. 11, 2024 (KR) 10-2024-0158777

(51) Int. Cl. G09G 3/3233; G09G 3/00; G09G 3/20

(52) U.S. Cl. CPC G09G 3/3233; G09G 3/006; G09G 3/2007; G09G 2300/0842; G09G 2320/0233; G09G 2320/045; G09G 2330/021; G09G 2330/12

(57) ABSTRACT

The present disclosure may provide a display device comprising a display panel including a plurality of subpixels including a light emitting element and a driving transistor, a gate driving circuit supplying a scan signal to the plurality of subpixels, a data driving circuit supplying a data voltage to the plurality of subpixels, a power management circuit supplying a pixel driving voltage to the plurality of subpixels, a emission current sensor detecting a variation in the emission current flowing through the light emitting element in a emission current detecting interval, and a controller controlling the power management circuit according to the variations in the emission current detected by the emission current sensor.

### CROSS-REFERENCE TO RELATED APPLICATION

This application claims priority from Republic of Korea Patent Application No. 10-2024-0158777, filed on Nov. 11, 2024, which is hereby incorporated by reference in its entirety.

### BACKGROUND

### Field

Embodiments of the disclosure relate to a display device and a display driving method and, more specifically, to a display device and a display driving method that may compensate for luminance changes according to variations in the characteristic value of the light emitting element.

### Description of Related Art

As information technology develops, the market for display devices, which are user-to-information connecting media, is growing. Accordingly, various display devices, such as organic light emitting display (OLED), quantum dot display (QDD), liquid crystal display (LCD), and plasma display panel (PDP), are increasingly used.

The display device includes a display panel where a plurality of subpixels are arranged, and various driving circuits such as a data driving circuit and a gate driving circuit for driving the display panel. In the display panel of the display device, transistors, various electrodes, various signal lines, and the like are formed on a glass substrate, and the driving circuits that may be implemented as integrated circuits are mounted on a printed circuit and are electrically connected to the display panel through the printed circuit. However, this conventional structure is suitable for large display devices, but not for small display devices.

Meanwhile, many different electronic devices requiring small display devices, such as virtual reality (VR) devices and augmented reality (AR) devices, are emerging, and accordingly, micro display devices with very small display panels have been proposed.

These display devices are formed to have semiconductor chips in the form of integrated circuits (ICs) on a silicon substrate (silicon semiconductor substrate) and, in many cases, various driving circuits as well as the display panel in the display device are integrally formed.

As such, since the display device implementing virtual reality uses a silicon substrate, the emission current flowing through the light emitting element may fluctuate due to deterioration of the light emitting element and changes in characteristics of the driving transistor, resulting in luminance deterioration.

### SUMMARY

Accordingly, the inventors of the disclosure invented a display device and a display driving method capable of compensating for a change in characteristic values caused by a light emitting element by detecting an emission current flowing through the light emitting element.

Embodiments of the disclosure may provide a display device and a display driving method capable of accurately detecting and compensating for variations in emission current by varying a pixel low-potential voltage applied to the cathode electrode of the light emitting element.

Further, embodiments of the disclosure may provide a display device and a display driving method capable of detecting and compensating for variations in emission current for the entire area or local area of the display panel.

Embodiments of the disclosure may provide a display device and a display driving method capable of accurately detecting and compensating for variations in emission current by varying a reference voltage supplied to a reference voltage line.

Embodiments of the disclosure may provide a display device comprising a display panel including a plurality of subpixels including a light emitting element and a driving transistor, a gate driving circuit supplying a scan signal to the plurality of subpixels, a data driving circuit supplying a data voltage to the plurality of subpixels; a power management circuit supplying a pixel driving voltage to the plurality of subpixels, a emission current sensor detecting a variation in the emission current flowing through the light emitting element in a emission current detecting interval, and a controller controlling the power management circuit according to the variations in the emission current detected by the emission current sensor.

Embodiments of the disclosure may provide a display driving method for driving a display panel including a plurality of subpixels including a light emitting element and a driving transistor, comprising determining a fixed first pixel driving voltage and a variable second pixel driving voltage, turning off the driving transistor using the first pixel driving voltage, detecting a emission current flowing through the light emitting element by varying the second pixel driving voltage to a plurality of levels, determining a deterioration characteristic of the light emitting element based on the emission current, and compensating for the luminance of the display panel by reflecting the deterioration characteristic of the light emitting element.

According to embodiments of the disclosure, it is possible to compensate for a change in characteristic value due to the light emitting element by detecting the emission current flowing through the light emitting element.

According to embodiments of the disclosure, it is also possible to accurately detect and compensate for variations in emission current by varying a pixel low-potential voltage applied to the cathode electrode of the light emitting element.

According to embodiments of the disclosure, it is also possible to detect and compensate for variations in emission current for the entire area or local area of the display panel.

According to embodiments of the disclosure, it is also possible to perform low-power luminance correction appropriate for the display device by varying the pixel low-potential voltage applied to the cathode electrode of the light emitting element.

According to embodiments of the disclosure, it is also possible to accurately detect and compensate for variations in emission current by varying a reference voltage supplied to the reference voltage line.

### BRIEF DESCRIPTION OF DRAWINGS

The above and other objects, features, and advantages of the present disclosure will be more clearly understood from the following detailed description, taken in conjunction with the accompanying drawings, in which:

FIG. 1 is a view schematically illustrating a display device according to various embodiments of the disclosure;

FIG. 2 is a view illustrating an example of a system configuration and a subpixel circuit of a display device according to embodiments of the disclosure;

FIG. 3 is a view schematically illustrating a movement of electrons and holes in a driving transistor by a bias voltage in a display device according to embodiments of the disclosure;

FIG. 4 is a graph illustrating a change in an emission current flowing through a light emitting element according to a driving voltage in a display device according to embodiments of the disclosure;

FIG. 5 is a block diagram schematically illustrating a display device according to embodiments of the disclosure;

FIG. 6 is a view illustrating an example of an operation of detecting an emission current flowing through a light emitting element in a display device according to embodiments of the disclosure;

FIG. 7 is a flowchart illustrating a display driving method according to embodiments of the disclosure;

FIG. 8 is a view illustrating a current offset according to a temperature of a display panel in a display driving method according to embodiments of the disclosure;

FIG. 9 is a signal graph illustrating a process of detecting a emission current flowing through a light emitting element while changing a level of a variable voltage in a display driving method according to embodiments of the disclosure;

FIG. 10 is a view illustrating a pixel low-potential voltage varied for detecting a emission current in a display driving method according to embodiments of the disclosure;

FIG. 11 is a graph illustrating a process of determining a deterioration characteristic of a light emitting element using an emission current according to a variable pixel low-potential voltage in a display driving method according to embodiments of the disclosure;

FIG. 12 is a view illustrating a process of applying a compensated driving voltage to a display panel by reflecting a deterioration characteristic of a light emitting element in a display driving method according to embodiments of the disclosure;

FIG. 13 is a view illustrating a process of compensating for a pixel low-potential voltage of a display panel by reflecting a deterioration characteristic of a light emitting element in a display driving method according to embodiments of the disclosure;

FIG. 14 is a view illustrating another operation of detecting an emission current flowing through a light emitting element in a display device according to embodiments of the disclosure;

FIG. 15 is a signal graph illustrating a process of detecting an emission current flowing through a light emitting element while changing a level of a reference voltage in a display driving method according to embodiments of the disclosure; and

FIG. 16 is a view illustrating a reference voltage varied for detecting an emission current in a display driving method according to embodiments of the disclosure.

### DETAILED DESCRIPTION

Hereinafter, some embodiments of the disclosure will be described in detail with reference to exemplary drawings. In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosure will be described in detail with reference to the accompanying drawings.

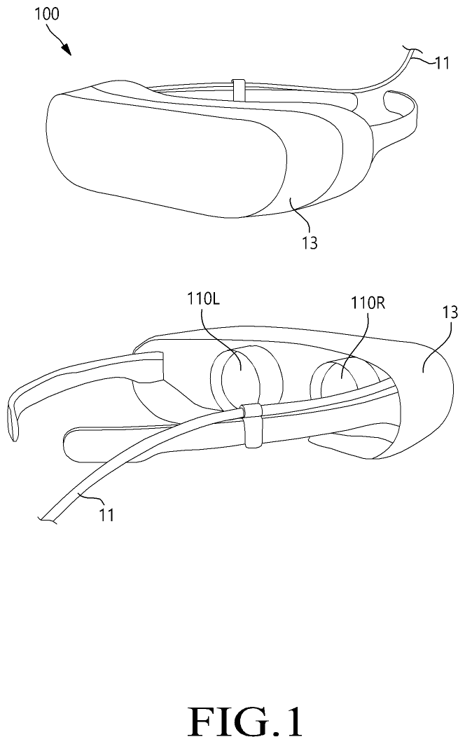

FIG. 1 is a view schematically illustrating a display device according to various embodiments of the disclosure.

Referring to FIG. 1, a display device 100 according to embodiments of the disclosure may be a head mounted display (HMD) type device, which is a type of wearable device capable of displaying images of augmented reality or virtual reality.

The display device 100 may include an image signal input unit 11 to which image data is input, a first display panel 110L on which a first image (e.g., a left-eye image) based on an image signal is displayed, a second display panel 110R on which a second image (e.g., a right-eye image) based on an image signal is displayed, and a case 13.

The image signal input unit 11 may include a wired cable or a wireless communication module connected to a host system (e.g., a smartphone, a laptop, etc.) that outputs image data. Here, although the image signal input unit 11 is illustrated as a wired line, the image signal input unit 11 may be implemented as a wireless interface.

The first display panel 110L and the second display panel 110R are formed at positions corresponding to the user's left eye and right eye. The combination of the first display panel 110L, the second display panel 110R, and a driving circuit for driving them may be referred to as the display device 100.

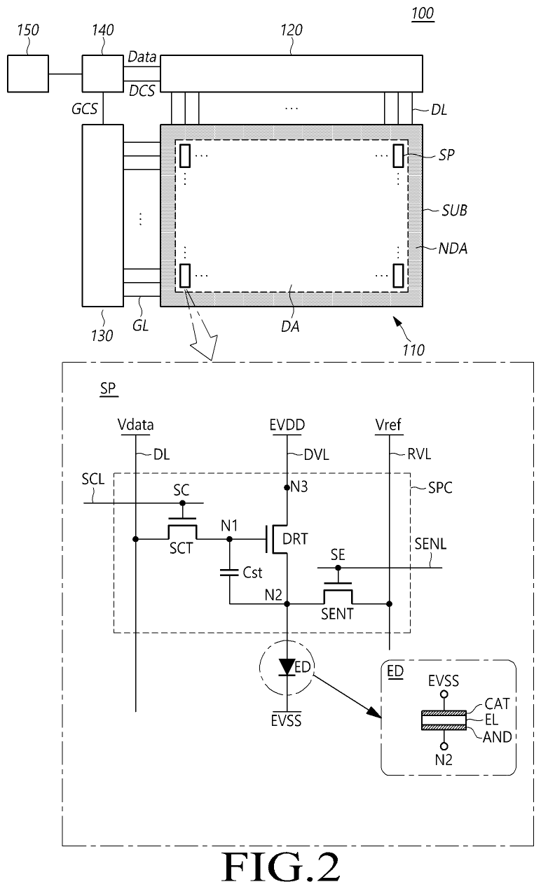

FIG. 2 is a view illustrating an example of a system configuration and a subpixel circuit of a display device according to embodiments of the disclosure.

Referring to FIG. 2, a display device 100 according to embodiments of the disclosure may include a display panel 110 including a plurality of subpixels SP and driving circuits for driving the plurality of subpixels SP included in the display panel 110.

The driving circuits may include a data driving circuit 120 and a gate driving circuit 130. The display device 100 may further include a controller 140 controlling the data driving circuit 120 and the gate driving circuit 130.

The display panel 110 may include a substrate SUB and signal lines, such as a plurality of data lines DL and a plurality of gate lines GL disposed on the substrate SUB. The plurality of data lines DL and the plurality of gate lines GL may be connected to the plurality of subpixels SP.

The display panel 110 may include a display area DA in which images are displayed and a non-display area NDA in which no image is displayed. In the display panel 110, a plurality of subpixels SP for displaying images may be disposed in the display area DA, and the driving circuits 120, 130, and 140 may be electrically connected or disposed in the non-display area NDA. Further, pad units for connection of integrated circuits or a printed circuit may be disposed in the non-display area NA.

The data driving circuit 120 is a circuit for driving the plurality of data lines DL and may supply data signals to the plurality of data lines DL.

The gate driving circuit 130 is a circuit for driving the plurality of gate lines GL and may supply gate signals to the plurality of gate lines GL.

The controller 140 may supply a data control signal DCS to the data driving circuit 120 to control the operation timing of the data driving circuit 120 and may supply a gate control signal GCS to the gate driving circuit 130 to control the operation timing of the gate driving circuit 130.

The controller 140 may start scanning according to a timing implemented in each frame, convert input image data input from the outside into image data Data suited for the data signal format used in the data driving circuit 120, supply the image data Data to the data driving circuit 120, and control data driving at an appropriate time suited for scanning.

The controller 140 receives, from the outside (e.g., a host system 150), various timing signals including a vertical synchronization signal VSYNC, a horizontal synchronization signal HSYNC, an input data enable signal DE, and a clock signal, along with the input image data.

To control the data driving circuit 120 and the gate driving circuit 130, the controller 140 receives timing signals, such as the vertical synchronization signal VSYNC, horizontal synchronization signal HSYNC, input data enable signal DE, and clock signal CLK, generates various control signals DCS and GCS, and outputs the control signals to the data driving circuit 120 and the gate driving circuit 130.

The data driving circuit 120 receives the image data Data from the controller 140 and supply data voltages to the plurality of data lines DL, thereby driving the plurality of data lines DL. The data driving circuit 120 is also referred to as a ‘source driving circuit.’

The data driving circuit 120 may include one or more source driver integrated circuits SDIC.

The gate driving circuit 130 may output a gate signal of a turn-on level voltage or a gate signal of a turn-off level voltage according to the control of the controller 140. The gate driving circuit 130 may sequentially drive the plurality of gate lines GL by sequentially supplying gate signals of the turn-on level voltage to the plurality of gate lines GL.

The gate driving circuit 130 may be connected with the display panel 110 by a tape automated bonding (TAB) method or connected to a bonding pad of the display panel 110 by a chip on glass (COG) or chip on panel (COP) method or may be connected with the display panel 110 according to a chip on film (COF) method.

Alternatively, the gate driving circuit 130 may be formed in a gate in panel (GIP) type, in the non-display area NDA of the display panel 110. The gate driving circuit 130 may be disposed on the substrate SUB or may be connected to the substrate SUB.

Meanwhile, at least one of the data driving circuit 120 and the gate driving circuit 130 may be disposed in the display area DA. For example, at least one of the data driving circuit 120 and the gate driving circuit 130 may be disposed not to overlap the subpixels SP or to overlap all or some of the subpixels SP. In another example, the gate driving circuit 130 may be formed in a gate in active (GIA) type in which the gate driving circuit 130 may be disposed in the display area DA in a distributed manner.

When a selected gate line GL is driven by the gate driving circuit 130, the data driving circuit 120 may convert the image data Data received from the controller 140 into an analog data voltage and supply it to the plurality of data lines DL.

The data driving circuit 120 may be connected to one side (e.g., an upper or lower side) of the display panel 110. Depending on the driving scheme or the panel design scheme, data driving circuits 120 may be connected with both the sides (e.g., both the upper and lower sides) of the display panel 110, or two or more of the four sides of the display panel 110.

The gate driving circuit 130 may be connected to one side (e.g., a left or right side) of the display panel 110. Depending on the gate driving scheme and the panel design scheme, gate driving circuits 130 may be connected with both the sides (e.g., both the left and right sides) of the display panel 110, or two or more of the four sides of the display panel 110.

The controller 140 may be mounted on a printed circuit board or a flexible printed circuit and may be electrically connected with the data driving circuit 120 and the gate driving circuit 130 through the printed circuit board or the flexible printed circuit.

The controller 140 may transmit/receive signals to/from the data driving circuit 120 according to one or more predetermined interfaces. The interface may include, e.g., a low voltage differential signaling (LVDS) interface, an embedded clock point to point interface (EPI), and a serial peripheral interface (SPI).

The controller 140 may include a storage medium, such as one or more registers.

The display device 100 according to embodiments of the disclosure may be a display including a backlight unit, such as a liquid crystal display, or may be a self-emission display, such as an organic light emitting display device, a quantum dot display device, or an inorganic light emitting display device. When the display device 100 according to embodiments of the disclosure is an organic light emitting display device, each subpixel SP may include an organic light emitting diode (OLED), which is self-emissive, as the light emitting element.

When the display device 100 according to embodiments of the disclosure is a self-emission display, each of the plurality of subpixels SP disposed on the display panel 110 of the display device 100 according to embodiments of the disclosure may include a light emitting element ED and a subpixel circuit SPC for driving the light emitting element ED.

Each subpixel circuit SPC may include a driving transistor DRT, a scan transistor SCT, a sensing transistor SENT, and a storage capacitor Cst. In this case, as each subpixel circuit SPC includes three transistors DRT, SCT, and SENT, and one capacitor Cst, it may be referred to as having a 3T (transistor) 1C (capacitor) structure. In some cases, the subpixel circuit SPC may further include one or more transistors or may further include one or more capacitors, but embodiments of the disclosure are not limited thereto. For example, the subpixel circuit SPC may have a 8T1C structure including 8 transistors and 1 capacitor. As another example, the subpixel circuit SPC may have a 6T2C structure including 6 transistors and 2 capacitors. As another example, the subpixel circuit SPC may have a 7T1C structure including 7 transistors and 1 capacitor, but embodiments of the disclosure are not limited thereto.

The light emitting element ED may include an anode electrode AND and a cathode electrode CAT and may include a light emitting layer EL positioned between the anode electrode AND and the cathode electrode CAT.

One of the anode electrode AND and the cathode electrode CAT may be a pixel electrode connected to a transistor, such as the driving transistor DRT, and the other may be a common electrode to which the common voltage is applied. Here, the pixel electrode is an electrode disposed in each subpixel SP, and the common electrode is an electrode commonly disposed in all subpixels SP. For example, the common voltage may be a high-level pixel high-potential voltage EVDD or a low-level pixel low-potential voltage EVSS. Here, the pixel low-potential voltage EVSS may also be referred to as a base voltage, and the pixel high-potential voltage EVDD and the pixel low-potential voltage EVSS may also be referred to as a pixel driving voltage.

The anode electrode AND may be a pixel electrode connected to a transistor, such as the driving transistor DRT, and the cathode electrode CAT may be a common electrode to which the pixel low-potential voltage EVSS is applied.

The scan signal line SCL is a line for supplying the scan signal SC corresponding to the first gate signal to the subpixel SP, and the sensing signal line SENL is a line for supplying the sensing signal SE corresponding to the second gate signal to the subpixel SP.

The driving transistor DRT is a transistor for driving the light emitting element ED, and may include a first node N1, a second node N2, and a third node N3.

The first node N1 of the driving transistor DRT may be a gate node of the driving transistor DRT and may be electrically connected with a source node or a drain node of the scan transistor SCT. The second node N2 of the driving transistor DRT may be a source node or a drain node of the driving transistor DRT, and may be electrically connected to the anode electrode AND of the light emitting element ED. The third node N3 of the driving transistor DRT may be electrically connected with a pixel high-potential voltage line DVL supplying a pixel high-potential voltage EVDD.

The gate node of the scan transistor SCT may be connected to the scan signal line SCL, and the gate node of the sensing transistor SENT may be connected to the sensing signal line SENL. Accordingly, the scan transistor SCT and sensing transistor SENT may operate independently of each other.

The on-off timings of the scan transistor SCT and the on-off timings of the sensing transistor SENT in one subpixel SP may be independent. In other words, the on-off timings of the scan transistor SCT and the on-off timings of the sensing transistor SENT in one subpixel SP may be the same or different.

The scan transistor SCT may be turned on by the scan signal SC having a turn-on level voltage and transfer the data voltage Vdata supplied from the data line DL to the first node N1 of the driving transistor DRT.

The sensing transistor SENT is connected between the second node N2 of the driving transistor DRT and the reference voltage line RVL. Therefore, when the sensing signal SE of the turn-on level is applied, the voltage of the second node N2 of the driving transistor DRT may be detected through the reference voltage line RVL.

Therefore, the display device 100 may detect the characteristic value (e.g., threshold voltage or mobility) of the driving transistor DRT through the sensing transistor SENT through the second node N2. The reference voltage Vref may be applied through the reference voltage line RVL during a sensing period which may be an interval in which the characteristic value of the driving transistor DRT is detected through the sensing transistor SENT.

The storage capacitor Cst may be electrically connected between the first node N1 and second node N2 of the driving transistor DRT. The storage capacitor Cst may be charged with the quantity of electric charge corresponding to the voltage difference between both ends thereof and may serve to maintain the voltage difference between both ends for a predetermined frame time. Accordingly, during the predetermined frame time, the corresponding subpixel SP may emit light.

The subpixel SP illustrated herein is merely an example, and various changes may be made thereto, e.g., such as further including one or more transistors or one or more capacitors.

The brightness of the subpixel SP is proportional to the emission current flowing through the light emitting element ED, and the emission current is greatly affected by the threshold voltage of the driving transistor DRT.

Meanwhile, when forming a transistor on a silicon wafer (Si wafer), the transistor is significantly deteriorated due to the high thermal conductivity of silicon (Si) itself.

In particular, in the case of n-type driving transistors, the current reduction due to deterioration of the driving transistor occurs more significantly due to the body effect.

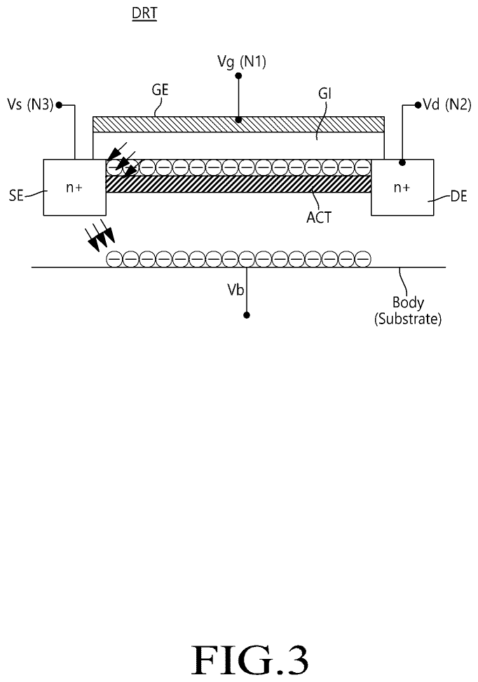

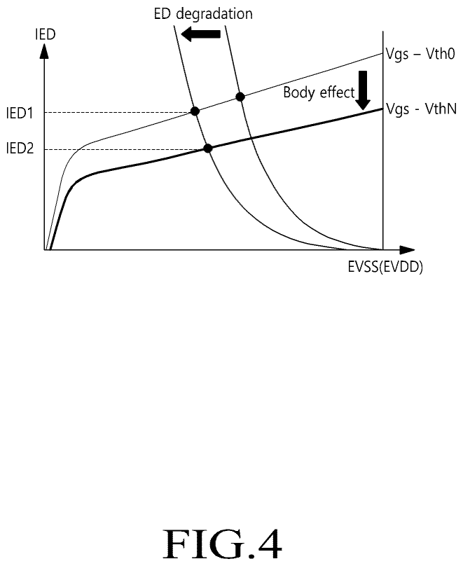

FIG. 3 is a view schematically illustrating a movement of electrons and holes in a driving transistor by a bias voltage in a display device according to embodiments of the disclosure. FIG. 4 is a graph illustrating a change in a emission current flowing through a light emitting element according to a driving voltage in a display device according to embodiments of the disclosure.

First, referring to FIG. 3, in the display device 100 according to embodiments of the disclosure, the transistor constituting the subpixel SP may have an active layer ACT of a semiconductor material between the source electrode SE and the drain electrode DE on the substrate, and a gate insulation film GI and a gate electrode GE formed on the active layer ACT.

In this case, since the gate insulation film GI has low thermal conductivity, it may be difficult for heat to escape through the separation space between the active layer ACT and the gate electrode GE.

In this state, when the gate voltage Vg is applied to the gate electrode GE and the drain voltage Vd is applied to the drain electrode DE, a channel area is formed in the active layer ACT between the drain electrode DE and the source electrode SE.

In the channel area, holes and electrons of the source electrode SE and the drain electrode DE are exchanged. In other words, in case of n-type driving transistors, electrons move from the source electrode SE to the drain electrode DE, and holes move from the drain electrode DE to the source electrode SE.

In this case, electrons are accelerated by applying the bias voltages Vg and Vd, and a drain avalanche occurs in which a large amount of electrons and holes are generated in the drain electrode DE. As a result, the generated electrons exit to the drain electrode DE, and the holes exit to the source electrode SE again through the channel area.

However, the holes entering the source electrode SE through the channel area are moved to the lower portion of the active layer ACT by the gate voltage Vg applied to the gate electrode GE. In this case, when some holes move through the active layer ACT to the source electrode SE, they remain trapped in the body (substrate) interface under the active layer ACT.

As such, the increase in the hole concentration in the source electrode SE causes an effect of lowering the barrier to be overcome when electrons move from the source electrode SE to the drain electrode DE through the active layer ACT. In other words, the threshold voltage of the transistor decreases a predetermined time after the gate voltage Vg is applied to the gate electrode GE and the drain voltage Vd is applied to the drain electrode DE.

As such, the phenomenon in which the concentration of the hole increases in the body (substrate) interface positioned under the active layer (ACT), lowering the source barrier and the threshold voltage of the transistor and extending depletion region is called the floating body effect.

Referring to FIG. 4, since the driving transistor constituting the subpixel deteriorates (ED) as the driving time increases, the emission current IED decreases due to the driving voltage (e.g., EVDD/EVSS).

At this time, by the body effect, the amount of electrons contributing to the drain avalanche increases significantly, which in turn increases the hole current. As a result, the source barrier is further lowered, causing positive feedback of the driving transistor, further deteriorating the characteristics of the driving transistor and reducing the luminance of the display panel 110.

For example, as the driving transistor's threshold voltage is increased by the body effect (e.g., Vth0->VthN), the emission current IED flowing through the light emitting element ED is decreased by the difference between the gate-source voltage Vgs and the threshold voltage.

In other words, the second emission current IED2 is less than the expected first emission current (e.g., IED1) due to the deterioration of the light emitting element ED flows through the light emitting element ED, further reducing the luminance of the display panel 110.

The deterioration of element characteristics due to the body effect is further increased in the case of an element formed of a short channel, and the effect may be increased in the case of a display panel 110 using a silicon substrate.

The disclosure discloses a method for detecting a variation in the emission current IED due to the body effect and effectively compensating for the same.

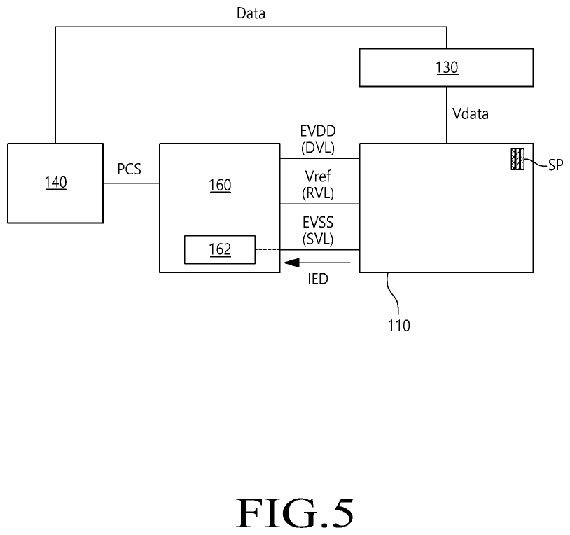

FIG. 5 is a block diagram schematically illustrating a display device according to embodiments of the disclosure.

Referring to FIG. 5, a display device 100 according to embodiments of the disclosure may include at least one source printed circuit board SPCB for circuit connection between a plurality of source driving integrated circuits SDIC constituting a data driving circuit 130 and other devices and a control printed circuit board CPCB for mounting control components and various electric devices.

In this case, the source film where the source driving integrated circuit SDIC is mounted may be connected to at least one source printed circuit board SPCB. In other words, one side of the source film where the source driving integrated circuit SDIC is mounted may be electrically connected with the display panel 110, and the other side thereof may be electrically connected with the source printed circuit board SPCB.

The controller 140 and the power management circuit 160 may be mounted on the control printed circuit board CPCB. The power management circuit 160 may supply driving voltage or current to the display panel 110, the data driving circuit 130, and the gate driving circuit 120 and control the supplied voltage or current, by a power management signal PCS supplied from the controller 140.

The power management circuit 160 of the display device 100 of the disclosure may control the pixel high-potential voltage EVDD supplied to the display panel 110 through the pixel high-potential voltage line DVL, the pixel low-potential voltage EVSS supplied to the display panel 110 through the pixel low-potential voltage line SVL, and the reference voltage Vref supplied to the display panel 110 through the reference voltage line RVL under the control of the controller 140.

The display device 100 of the disclosure may detect the source node voltage of the driving transistor DRT through the reference voltage line RVL in a state in which the sensing transistor SENT is turned on. In this case, the reference voltage Vref may be applied through the reference voltage line RVL in order to detect the source node voltage of the driving transistor DRT.

In this case, the combination of the pixel high-potential voltage EVDD, the pixel low-potential voltage EVSS, and the reference voltage Vref may also be referred to as the pixel driving voltage.

The power management circuit 160 may include an emission current sensor 162 that detects the emission current IED flowing through the light emitting element ED through the pixel low-potential voltage line SVL. The emission current sensor 162 may be positioned inside the power management circuit 160 or may be positioned on the control printed circuit board CPCB. For example, the emission current sensor 162 may be included in any other component of the display device.

The controller 140 may control the pixel high-potential voltage EVDD, the reference voltage Vref, and the pixel low-potential voltage EVSS output from the power management circuit 160 to detect the emission current IED flowing through the pixel low-potential voltage line SVL. Further, the controller 140 may control the image data Data supplied to the data driving circuit 130 to detect the emission current IED flowing through the pixel low-potential voltage line SVL.

In this case, the emission current IED flowing through the pixel low-potential voltage line SVL may be detected in a power-on interval during which power is applied to the display device 100, a power-off interval during which the power of the display device 100 is cut off, or a blank interval in the display driving period when the display panel 110 is driven.

The controller 140 may change the pixel high-potential voltage EVDD or the pixel low-potential voltage EVSS applied to the display panel 110 during the display driving period using the emission current IED detected in the power management circuit 160. In this case, the detected emission current IED may be transferred to the controller 140.

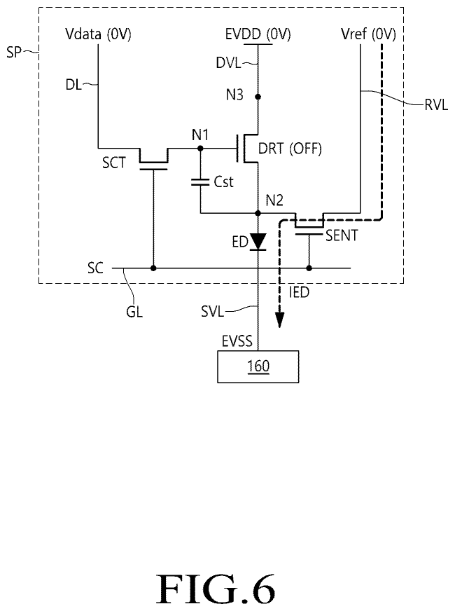

FIG. 6 is a view illustrating an example of an operation of detecting a emission current flowing through a light emitting element in a display device according to embodiments of the disclosure.

Referring to FIG. 6, the subpixel SP of the display device 100 according to embodiments of the disclosure may include a light emitting element ED, a driving transistor DRT, a scan transistor SCT, a sensing transistor SENT, and a storage capacitor Cst.

The display device 100 of the disclosure may detect the emission current IED in a power-on interval in which power is applied, a power-off interval in which power is cut off, or a blank interval in a display driving period.

In this case, the display device 100 of the disclosure may detect a change in the emission current IED by varying the pixel low-potential voltage EVSS applied to the cathode electrode of the light emitting element ED through the pixel low-potential voltage line SVL in a state in which the data voltage Vdata, the pixel high-potential voltage EVDD, and the reference voltage Vref are fixed.

For example, in the emission current detecting interval for detecting the emission current IED, the display device 100 of the disclosure may fix the data voltage Vdata applied to the subpixel SP, the pixel high-potential voltage EVDD, and the reference voltage Vref to 0V.

Accordingly, the driving transistor DRT is maintained in a turn-off state in the emission current detecting interval.

In this state, when the pixel low-potential voltage EVSS applied to the cathode electrode of the light emitting element ED is varied to two or more potentials, the power management circuit 160 may detect the emission current IED flowing from the reference voltage line RVL through the light emitting element ED.

In this case, the deviation between the reference voltage Vref and the pixel low-potential voltage EVSS may be varied in a range larger than the threshold voltage of the light emitting element ED so that the emission current IED may flow through the light emitting element ED in the emission current detecting interval.

The pixel low-potential voltage line SVL connected to the cathode electrode of the light emitting element ED may be commonly connected to all of the subpixels SP constituting the display panel 110. In this case, the emission current IED detected through the power management circuit 160 may correspond to the entire emission current of the display panel 110.

As described above, since the emission current IED has a non-linear relationship with the pixel high-potential voltage EVDD and the pixel low-potential voltage EVSS, three or more emission currents IED may be detected by applying the pixel low-potential voltage EVSS of different levels three or more times in the emission current detecting interval to accurately detect the emission current IED.

Specifically, since the current-voltage curve (I-V curve) of the light emitting element ED is non-linear, it is difficult to accurately determine the change in the curve by the pixel low-potential voltage (EVSS) with two different levels. Thus, it is possible to accurately detect the changed current-voltage curve (I-V curve) of the light emitting element ED using three or more emission current EVSS values detected through the pixel low-potential voltage EVSS with three or more different levels in the emission current detecting interval.

For example, a first emission current flowing through the pixel low-potential voltage line SVL may be detected by applying a first pixel low-potential voltage at a first time, a second emission current flowing the pixel low-potential voltage line SVL may be detected by applying a second pixel low-potential voltage at a second time, and a third emission current flowing through the pixel low-potential voltage line SVL may be detected by applying a third pixel low-potential voltage at a third time.

If the first to third emission currents corresponding to the first pixel low-potential voltage to the third pixel low-potential voltage are detected, a changed current-voltage curve I-V curve of the light emitting element ED may be obtained.

Therefore, the controller 140 may correct the luminance deviation of the display panel 110 by calculating the maximum emission current flowing through the light emitting element ED at the maximum gray level based on the changed current-voltage curve I-V curve for the light emitting element ED and changing the pixel high-potential voltage EVDD or pixel low-potential voltage EVSS applied to the display panel 110.

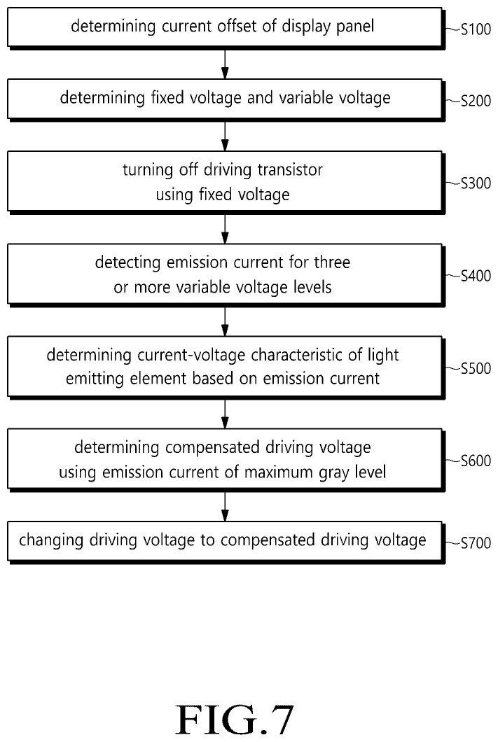

FIG. 7 is a flowchart illustrating a display driving method according to embodiments of the disclosure.

Referring to FIG. 7, a display driving method according to embodiments of the disclosure may include a step S100 of determining a current offset of a display panel, a step S200 of determining a fixed voltage and a variable voltage, a step S300 of turning off a driving transistor using the fixed voltage, a step S400 of detecting a emission current for three or more variable voltage levels, a step S500 of determining a current-voltage characteristic of a light emitting element based on the emission current, a step S600 of determining a compensated driving voltage using a emission current of a maximum gray level, and a step S700 of changing the driving voltage into the compensated driving voltage.

The step S100 of determining the current offset of the display panel 110 is a process of determining a reference value of the emission current IED flowing through the light emitting element ED. The reference value of the emission current IED flowing through the light emitting element ED may vary according to the temperature of the display panel 110.

Specifically, the current I=α(Vgs−Vth)2 flowing through the display panel 110 may be determined through the driving transistor DRT. Here, a is the mobility of the driving transistor DRT, Vgs is the voltage of the gate-source electrode of the driving transistor DRT, and Vth is the threshold voltage of the driving transistor DRT.

Therefore, when the mobility of the driving transistor DRT is determined, the current flowing through the subpixel SP of the display panel 110 may be determined by the driving transistor DRT.

In this case, the mobility of the driving transistor DRT may vary according to the temperature of the display panel 110.

Accordingly, the current offset of the display panel 110 may be determined by reflecting the temperature of the display panel 110 detected through the temperature sensor.

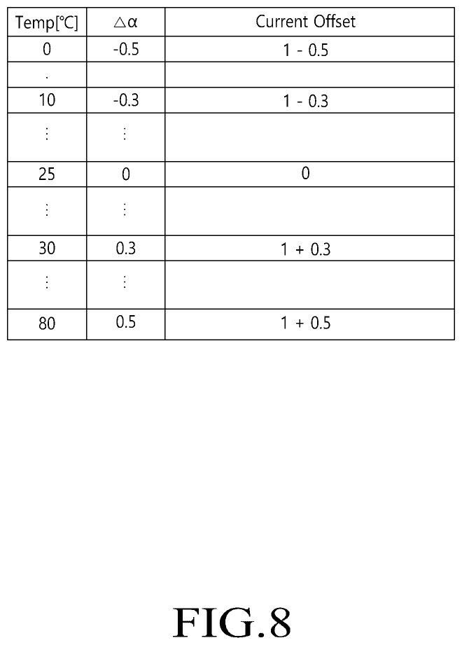

FIG. 8 is a view illustrating a current offset according to a temperature of a display panel in a display driving method according to embodiments of the disclosure.

Referring to FIG. 8, in the display panel 110 of the display device 100 according to embodiments of the disclosure, the mobility deviation of the driving transistor DRT at a reference temperature (e.g., 25° C.) may be zero.

However, when the temperature of the display panel 110 rises (e.g., 80° C.), the mobility of the driving transistor DRT increases, and as a result, the emission current IED flowing through the light emitting element ED may increase. Therefore, in this case, a current offset (e.g., 1+0.5=1.5) corresponding to the mobility deviation (e.g., 0.5) of the driving transistor DRT may be applied to the emission current IED. For example, when the temperature of the display panel 110 is 80° C., if the emission current IED of ImA is detected through the light emitting element ED, 1.5 times the current detected by applying a current offset of 1.5 (1.5*detection current) may be calculated as the emission current IED.

However, the step S100 of detecting the temperature of the display panel 110 and determining the current offset according to the temperature may be omitted from the display driving method of the disclosure.

The step S200 of determining the fixed voltage and the variable voltage is a process of setting a voltage applied to the subpixel SP in order to detect the emission current IED flowing through the light emitting element ED.

For example, as illustrated in FIG. 6, in order to detect the emission current IED flowing through the light emitting element ED, the data voltage Vdata, the pixel high-potential voltage EVDD, and the reference voltage Vref applied to the subpixel SP may be set as fixed voltages, and the pixel low-potential voltage EVSS may be set as a variable voltage.

Alternatively, the data voltage Vdata, the pixel high-potential voltage EVDD, and the pixel low-potential voltage EVSS applied to the subpixel SP may be set as a fixed voltage, and the reference voltage Vref may be set as a variable voltage.

The step S300 of turning off the driving transistor DRT using the fixed voltage is a process of turning off the driving transistor DRT through the fixed voltage to block the influence of the driving transistor DRT so as to detect the deterioration characteristics of the light emitting element ED.

For example, when the data voltage Vdata and the pixel high-potential voltage EVDD are fixed to 0V while the scan transistor SCT is turned on in the subpixel of FIG. 6, the driving transistor DRT may be turned off.

The step S400 of detecting the emission current IED for three or more variable voltage levels is a process of detecting the emission current IED flowing through the light emitting element ED while changing the level of the variable voltage three or more times in a state in which the driving transistor DRT is turned off.

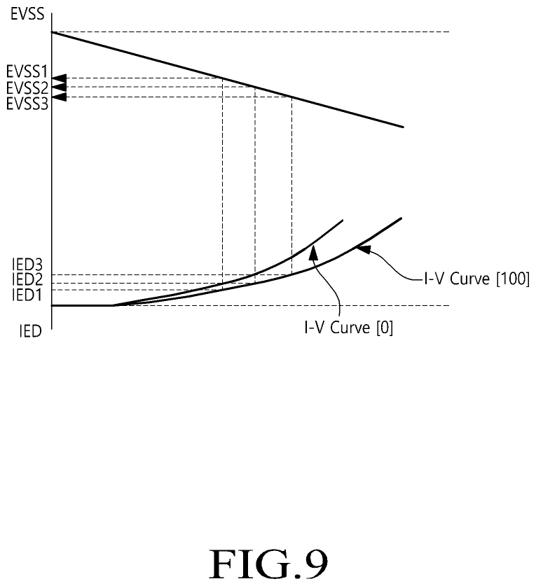

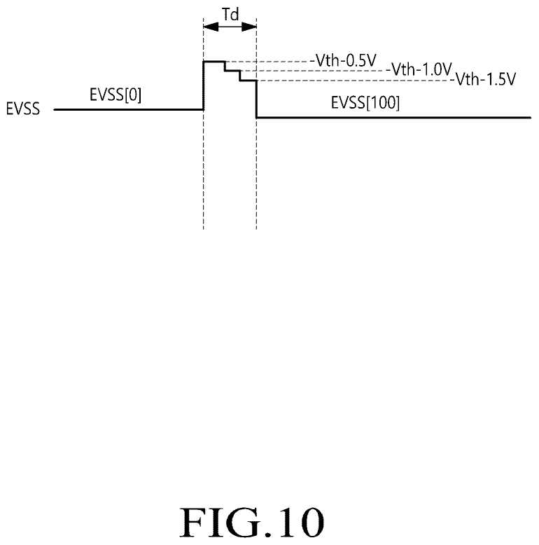

FIG. 9 is a signal graph illustrating a process of detecting an emission current flowing through a light emitting element while changing the level of a variable voltage in a display driving method according to embodiments of the disclosure, and FIG. 10 is a view illustrating a pixel low-potential voltage varied for emission current detection in a display driving method according to embodiments of the disclosure.

Referring to FIGS. 9 and 10, the display device 100 according to embodiments of the disclosure may detect the emission current IED flowing through the light emitting element ED while changing the level of the pixel low-potential voltage EVSS three or more times in the emission current detecting interval Td in a state in which the driving transistor DRT is turned off.

In this case, the emission current detecting interval Td may be included in a power-on interval before the display operation starts after the power signal is applied to the display device 100, a power-off interval before the operation ends after the power-off signal is applied to the display device 100, or a blank interval in the middle in which the display operation is performed.

For example, in a state in which the pixel low-potential voltage EVSS is sequentially changed to the first pixel low-potential voltage EVSS1 to the third pixel low-potential voltage EVSS3 in a state in which the reference voltage Vref is fixed at 0V, the emission currents IED1, IED2, and IED3 flowing through the light emitting element ED may be detected in each case.

Here, the I-V Curve [0] denotes the initial current-voltage curve of the light emitting element ED, and the I-V Curve denotes the current-voltage curve of the light emitting element ED detected through the display driving method of the disclosure after driving the display device 100 for 100 hours.

In this case, the display device 100 may store information about the initial current-voltage curve (I-V Curve[0]) of the light emitting element ED in the memory.

For example, by detecting the first emission current IED1 when the first pixel low-potential voltage EVSS1 is applied to the low-potential voltage line SVL, the second emission current IED2 when the second pixel low-potential voltage EVSS2 is applied, and the third emission current IED3 when the third pixel low-potential voltage EVSS3 is applied, the current-voltage curve (I-V Curve[100]) at the time of 100 hours of driving the light emitting element ED may be extracted.

In this case, the variable pixel low-potential voltage EVSS may be selected so that the deviation from the reference voltage Vref is larger than the threshold voltage of the light emitting element ED. Further, the first pixel low-potential voltage EVSS1, the second pixel low-potential voltage EVSS2, and the third pixel low-potential voltage EVSS3 for detecting the emission current IED may be selected at the same interval (e.g., 0.5 V). For example, the first pixel low-potential voltage EVSS1 may be set to a voltage 0.5V lower than the threshold voltage of the light emitting element ED, the second pixel low-potential voltage EVSS2 may be set to a voltage 1V lower than the threshold voltage of the light emitting element ED, and the third pixel low-potential voltage EVSS3 may be set to a voltage 1.5V lower than the threshold voltage of the light emitting element ED.

Here, for the pixel low-potential voltage EVSS, the initial pixel low-potential voltage EVSS[0] set by reflecting the initial current-voltage curve I-V Curve[0] of the light emitting element ED may differ from the compensated pixel low-potential voltage EVSS[100] set by reflecting the deteriorated current-voltage curve I-V Curve[100] after 100 hours of driving.

The step S500 of determining the current-voltage characteristic of the light emitting element ED based on the emission current IED is a process of determining the deterioration characteristic of the light emitting element ED by determining the current-voltage curve (I-V Curve[100]) of the light emitting element ED using the emission currents IED1, IED2, and EVSS3 corresponding to three or more different pixel low-potential voltages EVSS1, EVSS2, and EVSS3.

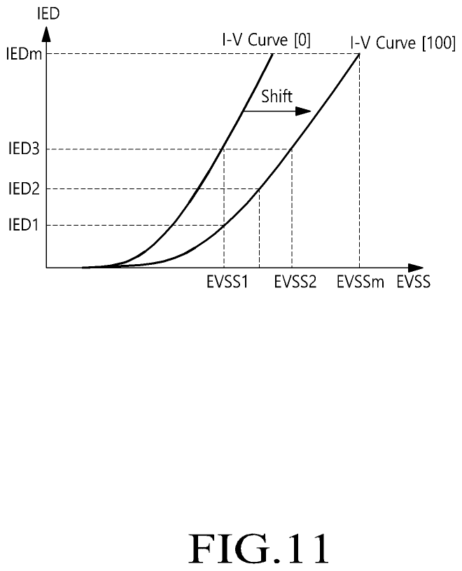

FIG. 11 is a graph illustrating a process of determining a current-voltage characteristic of a light emitting element using a emission current according to a variable pixel low-potential voltage in a display driving method according to embodiments of the disclosure.

Referring to FIG. 11, the display device 100 of the disclosure may detect the emission currents IED1, IED2, and IED3 flowing through the light emitting element ED while changing the pixel low-potential voltage EVSS to the first pixel low-potential voltage EVSS1 to the third pixel low-potential voltage EVSS3 with the reference voltage Vref fixed, in a state in which the driving transistor DRT is turned off.

As described above, the first emission current IED1 when the first pixel low-potential voltage EVSS1 is applied to the low-potential voltage line SVL, the second emission current IED2 when the second pixel low-potential voltage EVSS2 is applied, and the third emission current IED3 when the third pixel low-potential voltage EVSS3 is applied may be detected, and through this, the current-voltage curve I-V curve may be extracted when the light emitting element ED is driven for 100 hours.

The deterioration state of the light emitting element ED may be determined using the extracted current-voltage curve (I-V Curve[100]) at the time when the light emitting element ED is driven for 100 hours.

The step S600 of determining the compensated driving voltage using the emission current IEDm of the maximum gray level is a process of determining the compensated driving voltage at which the emission current IEDm of the maximum gray level may flow through the light emitting element ED at the maximum gray level (e.g., 255th gray level) from the detected current-voltage curve (I-V Curve[100]) of the light emitting element ED.

In order to compensate for the deterioration characteristic of the light emitting element ED, when the pixel low-potential voltage EVSS is controlled, the maximum pixel low-potential voltage EVSSm corresponding to the emission current IEDm of the maximum gray level in the current-voltage curve (I-V Curve[100]) of the light emitting element ED may be included in the compensated driving voltage.

In an embodiment, the compensated driving voltage may be determined based on a deviation between the previously set initial pixel low-potential voltage EVSS[0] and the maximum pixel low-potential voltage EVSSm derived from the updated current-voltage curve (I-V Curve[100]) of the light emitting element ED. For example, if the deviation between the initial pixel low-potential voltage EVSS[0] and the maximum pixel low-potential voltage EVSSm is smaller than a preset threshold, the pixel low-potential voltage EVSS may not be changed but may be maintained.

When the deviation between the initial pixel low-potential voltage EVSS[0] and the maximum pixel low-potential voltage EVSSm is larger than or equal to the threshold, the pixel low-potential voltage EVSS may be changed by a preset voltage value. For example, the pixel low-potential voltage EVSS may change the pixel low-potential voltage EVSS in a changeable resolution unit. (e.g., the threshold is set to 0.1V, and the pixel low-potential voltage EVSS is changed in units of 0.1V)

The maximum pixel low-potential voltage EVSSm corresponding to the updated current-voltage curve (I-V Curve[100]) of the light emitting element ED may be set as a reference value, and the maximum pixel low-potential voltage EVSSm may be compared with the maximum pixel low-potential voltage extracted in the subsequent emission current detecting interval. Whether the pixel low-potential voltage EVSS is changed and the level of a new pixel low-potential voltage EVSS may be determined based on the comparison result.

The step S700 of changing the driving voltage into the compensated driving voltage is a process of changing the driving voltage into a compensated driving voltage determined using the emission current IEDm of the maximum gray level.

In an embodiment, the data voltage (gamma voltage) corresponding to each gray level may be corrected according to a change in the pixel low-potential voltage EVSS. Accordingly, image quality deterioration caused by a change in the pixel low-potential voltage EVSS may be prevented or minimized.

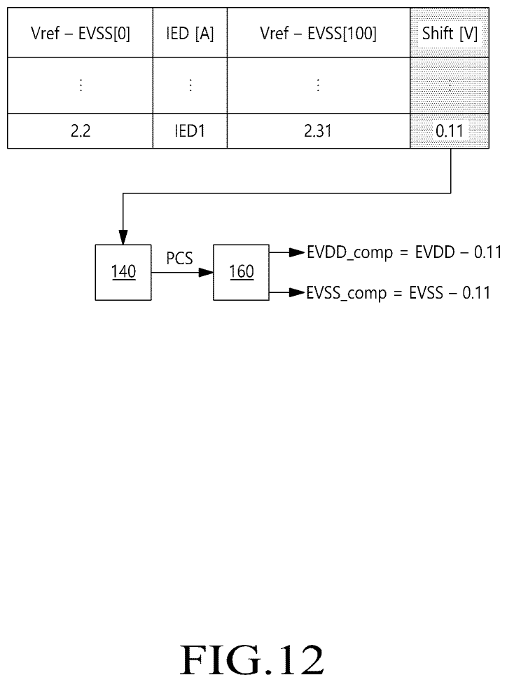

FIG. 12 is a view illustrating a process of applying a compensated driving voltage to a display panel by reflecting a deterioration characteristic of a light emitting element in a display driving method according to embodiments of the disclosure.

Referring to FIG. 12, the display device 100 of the disclosure may determine the current-voltage characteristic (I-V Curve[100]) of the light emitting element ED from three or more emission currents IED1, IED2, and IED3 flowing through the light emitting element ED in a state in which the driving transistor DRT is turned off and compensate for the pixel high-potential voltage EVDD or the pixel low-potential voltage EVSS with a compensated driving voltage corresponding to the emission current IEDm of the maximum gray level from the same.

For example, if the deviation between the initial pixel low-potential voltage EVSS[0] and the reference voltage Vref for forming the emission current IEDm of the maximum gray level in the initial state was 2.2V, but the deviation between the changed pixel low-potential voltage EVSS[100] and the reference voltage Vref for forming the emission current IEDm of the maximum gray level when the current-voltage characteristic (I-V Curve[100]) of the light emitting element ED deteriorated after 100 hours of driving is calculated as 2.31V, the current-voltage curve of the light emitting element ED may be determined to have been shifted by the difference voltage (e.g., 0.11V) between the initial pixel low-potential voltage EVSS[0] and the changed pixel low-potential voltage EVSS[100]. In this case, the shift voltage representing the deterioration characteristic of the light emitting element ED may be said to be the difference in the pixel low-potential voltage EVSS for forming the emission current IEDm of the maximum gray level.

Therefore, the compensated pixel high-potential voltage EVDD_comp and the compensated pixel low-potential voltage EVSS_comp may be supplied so as to be changed by the difference voltage (e.g., 0.11V) between the initial pixel low-potential voltage EVSS[0] and the changed pixel low-potential voltage EVSS[100].

Meanwhile, in order to compensate for the deterioration characteristic of the light emitting element ED, the pixel high-potential voltage EVDD and the pixel low-potential voltage EVSS may be simultaneously controlled, but the pixel high-potential voltage EVDD may be fixed while only the pixel low-potential voltage EVSS may be controlled.

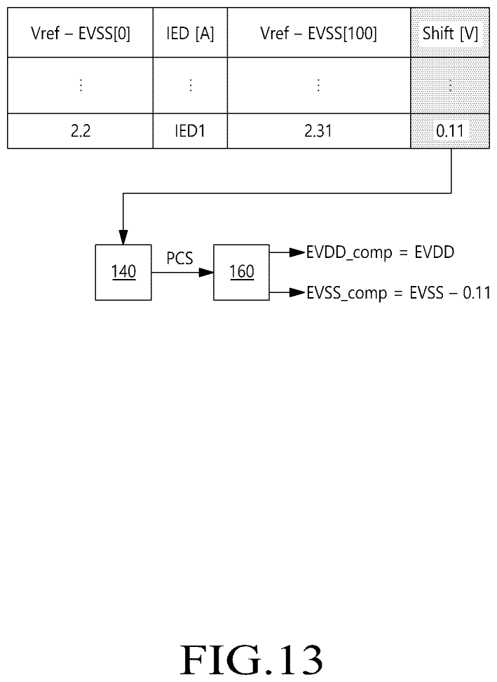

FIG. 13 is a view illustrating a process of compensating for a pixel low-potential voltage of a display panel by reflecting a deterioration characteristic of a light emitting element in a display driving method according to embodiments of the disclosure.

Referring to FIG. 13, the display device 100 of the disclosure may determine a deterioration characteristic of the light emitting element ED from the emission current IED flowing through the light emitting element ED in a state in which the driving transistor DRT is turned off, and apply the compensated pixel low-potential voltage EVSS_comp applied to the display panel 110 to form the emission current IEDm of the maximum gray level.

For example, if the deviation between the initial pixel low-potential voltage EVSS[0] and the reference voltage Vref for forming the emission current IEDm of the maximum gray level in the initial state was 2.2V, but the deviation between the changed pixel low-potential voltage EVSS[100] and the reference voltage Vref for forming the emission current IEDm of the maximum gray level when the current-voltage characteristic (I-V Curve[100]) of the light emitting element ED deteriorated after 100 hours of driving is calculated as 2.31V, the current-voltage curve of the light emitting element ED may be determined to have been shifted by the difference voltage (e.g., 0.11V) between the initial pixel low-potential voltage EVSS[0] and the changed pixel low-potential voltage EVSS[100]. In this case, the shift voltage representing the deterioration characteristic of the light emitting element ED may be said to be the difference voltage in the pixel low-potential voltage EVSS for forming the emission current IEDm of the maximum gray level.

Therefore, the controller 140 may control the power management circuit 160 to change the pixel low-potential voltage EVSS by the difference voltage (e.g., 0.11V) between the initial pixel low-potential voltage EVSS[0] and the changed pixel low-potential voltage EVSS[100] and supply the compensated pixel low-potential voltage EVSS_comp.

As such, when the compensated pixel low-potential voltage EVSS_comp is changed by reflecting the deterioration characteristic of the light emitting element ED, the fixed pixel high-potential voltage EVDD may be determined considering the variation width of the pixel low-potential voltage EVSS.

As such, when the deterioration characteristic of the light emitting element ED is compensated by controlling only the pixel low-potential voltage EVSS, power consumption may be decreased compared to when the pixel high-potential voltage EVDD and the pixel low-potential voltage EVSS are controlled together.

Meanwhile, the floating body effect of lowering the threshold voltage of the transistor due to the increase in the concentration of the holes at the body (substrate) interface positioned under the active layer ACT may differ according to the gray level of the image displayed through the display panel 110.

For example, when the process of compensating for luminance by changing the driving voltage EVDD or EVSS by reflecting the deterioration characteristic of the light emitting element ED in the display driving method of the disclosure proceeds in the blank interval of the display driving period, the image gray level of the frame with the blank interval may be reflected.

However, when the gray level of the image displayed through the display panel 110 is changed, the deterioration characteristic of the light emitting element ED may vary.

Therefore, the display driving method of the disclosure may further include the step of correcting the gamma value of the data voltage based on the reference gray level for the image at the time of changing the driving voltage EVDD or EVSS by reflecting the deterioration characteristic of the light emitting element ED.

For example, the emission current IED=α(Vgs−Vth)2 flowing through the display panel 110 through the driving transistor DRT may be determined. Here, a is the mobility of the driving transistor DRT, Vgs is the voltage of the gate-source electrode of the driving transistor DRT, and Vth is the threshold voltage of the driving transistor DRT.

In this case, when the shift voltage according to the deterioration characteristic of the driving transistor DRT is reflected,

$$Vgs = Vdata - Vref , and Vth = Vth 0 + \frac{Cdep}{Cox} ( Vs - Vb )$$

may be expressed.

Here, Vdata is the data voltage, and Vref is the reference voltage. Further, Vth0 is the initial threshold voltage of the driving transistor DRT, Cdep is the capacitance formed between the source electrode SE and the gate electrode GE of the driving transistor DRT, and Cox is the capacitance formed between the source electrode SE of the driving transistor DRT and the body (substrate). Further, Vs is the source voltage applied to the source electrode SE of the driving transistor DRT, and Vb is the body voltage formed at the body (substrate) of the driving transistor DRT.

Therefore, the emission current IED1 reflecting the image gray level of the reference frame for detecting the emission current IED may be represented as follows.

$$IED 1 = α [ ( Vdata 1 - Vref ) - ( Vth 0 + \frac{Cdep}{Cox} ( Vs 1 - Vb ) ) ] 2$$

Here, Vdata1 is the data voltage applied in the reference frame, and Vs1 is the source voltage applied to the source electrode SE of the driving transistor DRT in the reference frame.

In this state, when the shift voltage Vshift reflecting the deterioration characteristic of the light emitting element ED is applied, the emission current IED2 may be represented as follows.

$$IED 2 = α [ ( Vdata 1 - Vref ) - ( Vth 0 + \frac{Cdep}{Cox} ( Vs 1 - Vshift - Vb ) ) ] 2$$

Here, the emission current IEDN when the data voltage VdataN changed according to the gray level of the image is applied may be represented as follows.

$$IEDN = α [ ( VdataN - Vref ) - ( Vth 0 + \frac{Cdep}{Cox} ( Vs N - Vshift - Vb ) ) ] 2$$

Here, VdataN is the data voltage that changes according to the gray level of the image, and VsN is the source voltage applied to the source electrode SE of the driving transistor DRT according to the gray level of the image.

Therefore, the data voltage VdataN for each gray level of the image in a state in which the shift voltage Vshift reflecting the deterioration characteristic of the light emitting element ED is applied may be corrected as follows.

$$VdataN = Vdata 1 + \frac{Cdep}{Cox} ( VsN - Vshiftt )$$

As described above, the display driving method of the disclosure may more precisely provide luminance compensation due to the deterioration of the light emitting element ED by controlling the data voltage Vdata according to the gray level of the image displayed through the display panel 110.

Meanwhile, the display device 100 of the disclosure may detect the emission current IED flowing through the light emitting element ED by varying the reference voltage Vref applied to the reference voltage line RVL in a state in which the pixel low-potential voltage EVSS is fixed.

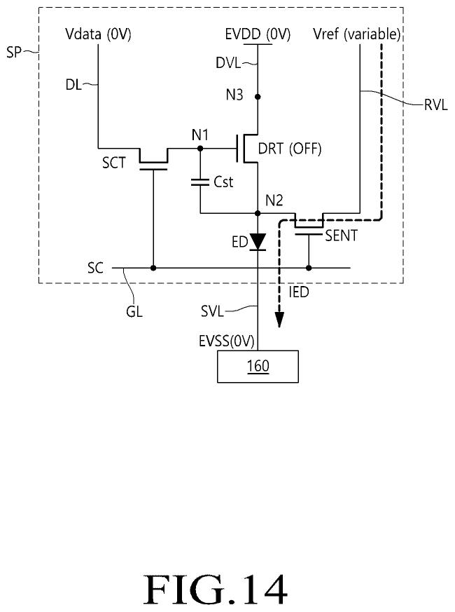

FIG. 14 is a view illustrating another operation of detecting an emission current flowing through a light emitting element in a display device according to embodiments of the disclosure.

Referring to FIG. 14, the subpixel SP of the display device 100 according to embodiments of the disclosure may include a light emitting element ED, a driving transistor DRT, a scan transistor SCT, a sensing transistor SENT, and a storage capacitor Cst.

The display device 100 of the disclosure may detect the emission current IED in a power-on interval in which power is applied, a power-off interval in which power is cut off, or a blank interval in a display driving period.

In this case, the display device 100 of the disclosure may detect a change in the emission current IED by varying the reference voltage Vref applied to the anode electrode of the light emitting element ED through the reference voltage line RVL in a state in which the data voltage Vdata, the pixel high-potential voltage EVDD, and the pixel low-potential voltage EVSS are fixed.

For example, the display device 100 of the disclosure may fix the potential of the data voltage Vdata, the pixel high-potential voltage EVDD, and the pixel low-potential voltage EVSS applied to the subpixel SP in the emission current detecting interval for detecting the emission current IED to 0V in a state in which the scan transistor SCT and the sensing transistor SENT are turned on through the turn-on level scan signal SC.

Accordingly, the driving transistor DRT is maintained in a turn-off state in the emission current detecting interval.

In this state, when the reference voltage Vref applied to the anode electrode of the light emitting element ED is varied to three or more different levels through the sensing transistor SENT, the emission current IED flowing from the reference voltage line RVL through the light emitting element ED may be detected by the power management circuit 160.

In this case, the pixel low-potential voltage line SVL connected to the cathode electrode of the light emitting element ED may be commonly connected to all of the subpixels SP constituting the display panel 110. In this case, the emission current IED detected through the power management circuit 160 may correspond to the entire emission current of the display panel 110.

As described above, since the emission current IED has a nonlinear relationship with the pixel high-potential voltage EVDD and the pixel low-potential voltage EVSS, the emission current IED may be detected three or more times by applying different reference voltages Vref three or more times in the emission current detecting interval to accurately detect the emission current IED.

For example, when the first reference voltage Vref1 is applied at a first time, the first emission current IED1 may be detected at the pixel low-potential voltage line SVL, and when the second reference voltage Vref2 is applied at a second time, the second emission current IED2 may be detected at the pixel low-potential voltage line SVL. Further, when the third reference voltage Vref3 is applied at a third time, the third emission current IED3 may be detected at the pixel low-potential voltage line SVL.

The controller 140 may determine the deteriorated current-voltage curve (I-V Curve[100]) of the light emitting element ED using the levels IED1, IED2, and IED3 of the emission current according to the levels Vref1, Vref2, and Vref3 of the reference voltage.

Therefore, the luminance deviation of the display panel 110 may be corrected by changing the pixel high-potential voltage EVDD or pixel low-potential voltage EVSS applied to the display panel 110 so that the emission current IEDm of the maximum gray level may be formed using the current-voltage curve I-V Curve[100] reflecting the deterioration state of the light emitting element ED

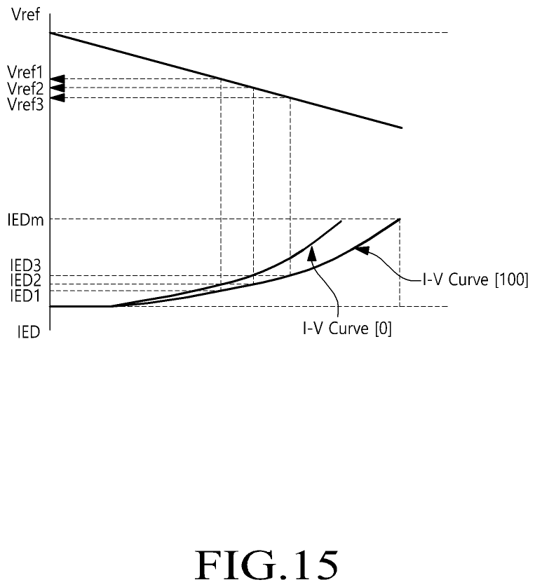

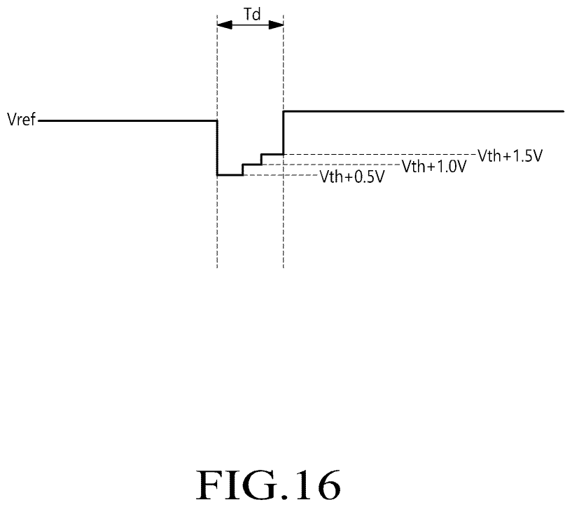

FIG. 15 is a signal graph illustrating a process of detecting a emission current flowing through a light emitting element while changing a level of a reference voltage in a display driving method according to embodiments of the disclosure, and FIG. 16 is a view illustrating a reference voltage varied for detecting a emission current in a display driving method according to embodiments of the disclosure.

Referring to FIGS. 15 and 16, the display device 100 according to embodiments of the disclosure may detect the emission current IED flowing through the light emitting element ED while changing the level of the reference voltage Vref three or more times in a state in which the driving transistor DRT is turned off.

In this case, the emission current detecting interval Td may be included in a power-on interval before the display operation starts after the power signal is applied to the display device 100, a power-off interval before the operation ends after the power-off signal is applied to the display device 100, or a blank interval in the middle in which the display operation is performed.

For example, the emission currents IED1, IED2, and IED3 flowing through the light emitting element ED may be detected in each case while sequentially changing the reference voltage Vref to the first reference voltage Vref1 to the third reference voltage Vref3 in a state in which the pixel low-potential voltage EVSS is fixed to 0.

Here, the I-V Curve[0] denotes the initial current-voltage curve of the light emitting element ED, and the I-V Curve denotes the current-voltage curve of the light emitting element ED detected through the display driving method of the disclosure after driving the display device 100 for 100 hours.

In this case, the display device 100 may store information about the initial current-voltage curve I-V curve[0] of the light emitting element ED in a memory.

For example, by detecting the first emission current IED1 when the first reference voltage Vref1 is applied to the reference voltage line RVL, the second emission current IED2 when the second reference voltage Vref2 is applied, and the third emission current IED3 when the third reference voltage Vref3 is applied, the current-voltage curve (I-V Curve) at the time of 100 hours of driving the light emitting element ED may be extracted.

In this case, the variable reference voltage Vref may be selected so that the deviation from the pixel low-potential voltage EVSS is larger than the threshold voltage of the light emitting element ED. Further, the first reference voltage Vref1, the second reference voltage Vref2, and the third reference voltage Vref3 for detecting the emission current IED may be selected at the same interval (e.g., 0.5 V).

Accordingly, the display device 100 of the disclosure may compensate for brightness deviation by compensating for the pixel high-potential voltage EVDD or pixel low-potential voltage EVSS applied to the display panel 110 by reflecting the deterioration characteristic of the light emitting element ED according to the emission current IED detected through the low-potential voltage line SVL.

In this case, as described above, in order to compensate for the luminance deviation, the levels of the pixel high-potential voltage EVDD and the pixel low-potential voltage EVSS may be controlled simultaneously, or only the level of the pixel low-potential voltage EVSS may be controlled in a state in which the pixel high-potential voltage EVDD is fixed.

Meanwhile, the pixel low-potential voltage line SVL connected to the cathode electrode of the light emitting element ED may be commonly connected to all of the subpixels SP constituting the display panel 110. Accordingly, compensating for the pixel high-potential voltage EVDD or pixel low-potential voltage EVSS applied to the display panel 110 by reflecting the deterioration characteristic of the light emitting element ED according to the emission current IED detected through the low-potential voltage line SVL may correspond to global compensation targeting the entire area of the display panel 110.

For the global compensation, in order to reflect the deterioration characteristic of each subpixel, the accumulated stress of each subpixel may be calculated by accumulating the image data displayed through the display panel 110 and additionally reflected.

Embodiments of the disclosure described above are briefly described below.

A display device of the disclosure may comprise a display panel including a plurality of subpixels including a light emitting element and a driving transistor, a gate driving circuit supplying a scan signal to the plurality of subpixels, a data driving circuit supplying a data voltage to the plurality of subpixels, a power management circuit supplying a pixel driving voltage to the plurality of subpixels, a emission current sensor detecting a variation in the emission current flowing through the light emitting element in a emission current detecting interval, and a controller controlling the power management circuit according to the variations in the emission current detected by the emission current sensor.

The emission current detecting interval may be positioned in at least one of a power-on interval in which power is applied to the display panel, a blank interval in a display driving period in which an image is displayed on the display panel, and a power-off interval in which the power to the display panel is cut off.

In the emission current detecting interval, the data voltage may be applied at a turn-off level so that the driving transistor may maintain a turn-off state.

The power management circuit may maintain a first pixel driving voltage in a fixed state and vary a second pixel driving voltage to a plurality of levels, thereby varying the emission current.

The first pixel driving voltage may include a pixel high-potential voltage supplied to the subpixel and a reference voltage applied to a reference voltage line connected to the driving transistor through the sensing transistor. The second pixel driving voltage may include a pixel low-potential voltage applied through a pixel low-potential voltage line connected to a cathode electrode of the light emitting element.

In the emission current detecting interval, the power management circuit may maintain the pixel high-potential voltage and the reference voltage at 0V and vary the pixel low-potential voltage to two or more levels.

The controller may detect the deterioration characteristic of the light emitting element by reflecting the deviation between the first pixel low-potential voltage and the second pixel low-potential voltage through which the same emission current flows.

The controller may determine the shift voltage of the light emitting element according to the deviation between the first pixel low-potential voltage and the second pixel low-potential voltage.

The power management circuit may simultaneously control the pixel high-potential voltage and the pixel low-potential voltage according to the variation in the emission current.

The power management circuit may control the pixel low-potential voltage according to the variation in the emission current.

The controller may further include a temperature sensor for detecting a temperature of the display panel, and may determine a current offset for the emission current according to the temperature of the display panel detected by the temperature sensor.

The first pixel driving voltage may include a pixel high-potential voltage supplied to the subpixel and a pixel low-potential voltage applied through a pixel low-potential voltage line connected to the cathode electrode of the light emitting element. The second pixel driving voltage may include a reference voltage applied through a sensing transistor to a reference voltage line connected to the driving transistor.

The power management circuit may maintain the pixel high-potential voltage and the pixel low-potential voltage at 0V, and vary the reference voltage to two or more levels in the emission current detecting interval.

The controller may detect the deterioration characteristic of the light emitting element by reflecting the deviation between the first reference voltage and the second reference voltage through which the same emission current flows.

The controller may determine the shift voltage of the light emitting element according to the deviation between the first reference voltage and the second reference voltage.

The emission current sensor may be positioned in the power management circuit.

The controller may, when the emission current detecting interval is included in a blank interval in a display driving period in which an image is displayed on the display panel, control the data driving circuit by reflecting a gray level of an image displayed through the display panel in the display driving period.

The controller may control the power management circuit by reflecting accumulated stress according to the data voltage for the plurality of subpixels.

Further, a display driving method for driving a display panel including a plurality of subpixels including a light emitting element and a driving transistor, according to the disclosure, may comprise determining a fixed first pixel driving voltage and a variable second pixel driving voltage, turning off the driving transistor using the first pixel driving voltage, detecting a emission current flowing through the light emitting element by varying the second pixel driving voltage to a plurality of levels, determining a deterioration characteristic of the light emitting element based on the emission current, and compensating for the luminance of the display panel by reflecting the deterioration characteristic of the light emitting element.

The display driving method may further comprise determining a current offset for the emission current according to a temperature of the display panel.

The display driving method may further comprise, when an interval for detecting the emission current is included in a blank interval in a display driving period in which an image is displayed on the display panel, controlling a data voltage supplied to the display panel by reflecting a gray level of an image displayed through the display panel in the display driving period.

Compensating for the luminance of the display panel may include reflecting accumulated stress according to the data voltage for the plurality of subpixels.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

What is claimed:

1. A display device, comprising:
a display panel including a subpixel, the subpixel comprising a light emitting element and a driving transistor connected to the light emitting element;
a power management circuit configured to supply a pixel high-potential voltage, a pixel low-potential voltage, and a reference voltage to the subpixel, the power management circuit further configured to vary the pixel low-potential voltage or the reference voltage in an emission current detecting interval;
an emission current sensor configured to detect a variation in an emission current flowing through the light emitting element in the emission current detecting interval; and
a controller configured to control the pixel low-potential voltage based on the detected variation in the emission current.

2. The display device of claim 1, wherein the emission current detecting interval is positioned in at least one of:
a power-on interval during which power is applied to the display panel;
a blank interval in a display driving period during which an image is displayed on the display panel; and
a power-off interval during which the power to the display panel is cut off.

3. The display device of claim 1, wherein in the emission current detecting interval, the data voltage is applied at a turn-off level such that the driving transistor maintains a turn-off state.

4. The display device of claim 1, wherein the pixel high-potential voltage is supplied to a first electrode of the driving transistor, wherein the reference voltage is supplied to a second electrode of the driving transistor and an anode electrode of the light emitting element through a sensing transistor included in the subpixel, and wherein the pixel low-potential voltage is supplied to a cathode electrode of the light emitting element.

5. The display device of claim 4, wherein the power management circuit maintains the pixel high-potential voltage and the reference voltage at zero volts and varies the pixel low-potential voltage to three or more different levels in the emission current detecting interval.

6. The display device of claim 5, wherein the pixel low-potential voltage is varied in a range in which a deviation from the reference voltage is larger than a threshold voltage of the light emitting element.

7. The display device of claim 5, wherein the three or more different levels have voltage intervals that are the same.

8. The display device of claim 4, wherein the power management circuit determines a level of a compensated pixel low-potential voltage based on a deviation between an initial pixel low-potential voltage where an emission current of a maximum gray level flows and a current pixel low-potential voltage where the emission current of the maximum gray level flows, and supplies the compensated pixel low-potential voltage to the display panel in a subsequent display interval.

9. The display device of claim 4, wherein the power management circuit changes the pixel high-potential voltage simultaneously based on a deviation between an initial pixel low-potential voltage where an emission current of a maximum gray level flows and a current pixel low-potential voltage where the emission current of the maximum gray level flows.

10. The display device of claim 1, wherein the controller further includes a temperature sensor configured to detect a temperature of the display panel and the controller determines a current offset for the emission current based on the temperature of the display panel detected by the temperature sensor.

11. The display device of claim 1, wherein the power management circuit maintains the pixel high-potential voltage and the pixel low-potential voltage at zero volts and varies the reference voltage to three or more different levels in the emission current detecting interval.

12. The display device of claim 1, wherein the emission current sensor is positioned in the power management circuit.

13. The display device of claim 1, wherein when the emission current detecting interval is included in a blank interval in a display driving period in which an image is displayed on the display panel, the controller controls a data voltage for each gray level by reflecting a gray level of an image displayed through the display panel in the display driving period.

14. The display device of claim 1, wherein the controller controls the power management circuit by reflecting accumulated stress according to the data voltage for the subpixel.

15. The display device of claim 1, wherein the detection result is a difference voltage between an initial pixel low-potential voltage and the detected pixel low-potential voltage corresponding to the initial pixel low-potential voltage, and
wherein the pixel low-potential voltage is changed by the difference voltage.

16. A display driving method for driving a display panel including a plurality of subpixels including a light emitting element and a driving transistor, the display driving method comprising:
determining a fixed first pixel driving voltage and a variable second pixel driving voltage;
turning off the driving transistor using the fixed first pixel driving voltage;
detecting a emission current flowing through the light emitting element by varying the variable second pixel driving voltage to three or more different levels;
determining a current-voltage characteristic of the light emitting element based on the emission current;
determining a compensated driving voltage using an emission current of a maximum gray level; and
changing the driving voltage of the display panel to the compensated driving voltage.

17. The display driving method of claim 16, further comprising
determining a current offset for the emission current according to a temperature of the display panel.

18. The display driving method of claim 16, further comprising:
when an interval for detecting the emission current is included in a blank interval in a display driving period in which an image is displayed on the display panel, controlling a data voltage for each gray level supplied to the display panel by reflecting a gray level of the image displayed through the display panel in the display driving period.

19. The display driving method of claim 18, wherein the data voltage for each gray level is determined by the following equation:
$$VdataN = Vdata 1 + \frac{Cdep}{Cox} ( VsN - Vshift )$$
wherein VdataN is a data voltage for each gray level, Vdata1 is a data voltage applied in a frame in which the emission current is detected, Cdep is a capacitance formed between a source electrode and a gate electrode of the driving transistor, Cox is a capacitance formed between a source electrode of the driving transistor and a body, VsN is a source voltage applied to the source electrode of the driving transistor reflecting the gray level, and Vshift is a shift voltage according to a variation in a current-voltage curve of the light emitting element.

20. The display driving method of claim 16, wherein compensating for a luminance of the display panel includes reflecting accumulated stress according to the data voltage for the plurality of subpixels.
